(19) United States
(12) Patent Application Publication
(10) Pub. No.: US 2024/0314359 A1
(43) Pub. Date: Sep. 19, 2024

(54) METHOD, APPARATUS, AND MEDIUM FOR POINT CLOUD CODING

(71) Applicants: Beijing Bytedance Network Technology Co., Ltd., Beijing (CN); Bytedance Inc., Los Angeles, CA (US)

(72) Inventors: Yingzhan XU, Beijing (CN); Wenyi Wang, Beijing (CN); Kai Zhang, Los Angeles, CA (US); Li Zhang, Los Angeles, CA (US)

(21) Appl. No.: 18/674,700

(22) Filed: May 24, 2024

Related U.S. Application Data
(63) Continuation of application No. PCT/CN2022/134478, filed on Nov. 25, 2022.

(30) Foreign Application Priority Data
Nov. 26, 2021 (WO) PCT/CN2021/133689

(51) Int. Cl. H04N 19/597; H04N 19/132; H04N 19/137; H04N 19/172; H04N 19/174; H04N 19/184

(52) U.S. Cl. CPC H04N 19/597; H04N 19/132; H04N 19/137; H04N 19/172; H04N 19/174; H04N 19/184

(57) ABSTRACT

Embodiments of the present disclosure provide a solution for point cloud coding. A method for point cloud coding comprises: determining, for a current point in a current point cloud (PC) sample of a point cloud sequence during a conversion between the current PC sample and a bitstream of the point cloud sequence, at least one neighboring point from a set of points in a reference PC sample of the current PC sample, the set of points being in a group of level of details (LODs) of the reference PC sample; and performing the conversion based on the at least one neighboring point. Compared with the conventional solution, the proposed method can advantageously improve the accuracy of the nearest neighbor search.

### CROSS REFERENCE

This application is a continuation of International Application No. PCT/CN2022/134478, filed on Nov. 25, 2022, which claims the benefit of International Application No. PCT/CN2021/133689 filed on Nov. 26, 2021. The entire contents of these applications are hereby incorporated by reference in their entireties.

### FIELD

Embodiments of the present disclosure relates generally to point cloud coding techniques, and more particularly, to optimized inter prediction for point cloud attribute coding based on the nearest neighbor search.

### BACKGROUND

A point cloud is a collection of individual data points in a three-dimensional (3D) plane with each point having a set coordinate on the X, Y, and Z axes. Thus, a point cloud may be used to represent the physical content of the three-dimensional space. Point clouds have shown to be a promising way to represent 3D visual data for a wide range of immersive applications, from augmented reality to autonomous cars.

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC or VPCC) is appropriate for point sets with a relatively uniform distribution of points. Geometry-based Point Cloud Compression (G-PCC or GPCC) is appropriate for more sparse distributions. However, coding efficiency of conventional point cloud coding techniques is generally expected to be further improved.

### SUMMARY

Embodiments of the present disclosure provide a solution for point cloud coding.

In a first aspect, a method for point cloud coding is proposed. The method comprises: determining, for a current point in a current point cloud (PC) sample of a point cloud sequence during a conversion between the current PC sample and a bitstream of the point cloud sequence, at least one neighboring point from a set of points in a reference PC sample of the current PC sample, the set of points being in a group of level of details (LODs) of the reference PC sample; and performing the conversion based on the at least one neighboring point.

Based on the method in accordance with the first aspect of the present disclosure, points in a group of LODs of the reference PC sample are searched to obtain the neighboring point of the current point. Compared with the conventional solution where only the points in the same LOD as the current point are searched, the proposed method can advantageously improve the accuracy of the nearest neighbor search and the attribute inter prediction.

In a second aspect, another method for point cloud coding is proposed. The method comprises: determining, for a current point in a current point cloud (PC) sample of a point cloud sequence during a conversion between the current PC sample and a bitstream of the point cloud sequence, a first plurality of neighboring points from points in a second plurality of PC samples of the point cloud sequence; and performing the conversion based on the first plurality of neighboring points, wherein the first plurality of neighboring points are stored in a third plurality of lists.

Based on the method in accordance with the second aspect of the present disclosure, the plurality of neighboring points of the current point are stored in more than one list. Compared with the conventional solution where neighboring points are stored in only one list, the proposed method can advantageously improve the efficiency of the nearest neighbor search and the attribute inter prediction.

In a third aspect, an apparatus for processing point cloud data is proposed. The apparatus for processing point cloud data comprises a processor and a non-transitory memory with instructions thereon. The instructions, upon execution by the processor, cause the processor to perform a method in accordance with the first or second aspect of the present disclosure.

In a fourth aspect, a non-transitory computer-readable storage medium is proposed. The non-transitory computer-readable storage medium stores instructions that cause a processor to perform a method in accordance with the first or second aspect of the present disclosure.

In a fifth aspect, a non-transitory computer-readable recording medium is proposed. The non-transitory computer-readable recording medium stores a bitstream of a point cloud sequence which is generated by a method performed by a point cloud processing apparatus. The method comprises: determining, for a current point in a current point cloud (PC) sample of the point cloud sequence, at least one neighboring point from a set of points in a reference PC sample of the current PC sample, the set of points being in a group of level of details (LODs) of the reference PC sample; and generating the bitstream based on the at least one neighboring point.

In a sixth aspect, a method for storing a bitstream of a point cloud sequence is proposed. The method comprises: determining, for a current point in a current point cloud (PC) sample of the point cloud sequence, at least one neighboring point from a set of points in a reference PC sample of the current PC sample, the set of points being in a group of level of details (LODs) of the reference PC sample; generating the bitstream based on the at least one neighboring point; and storing the bitstream in a non-transitory computer-readable recording medium.

In a seventh aspect, another non-transitory computer-readable recording medium is proposed. The non-transitory computer-readable recording medium stores a bitstream of a point cloud sequence which is generated by a method performed by a point cloud processing apparatus. The method comprises: determining, for a current point in a current point cloud (PC) sample of the point cloud sequence, a first plurality of neighboring points from points in a second plurality of PC samples of the point cloud sequence; and generating the bitstream based on the first plurality of neighboring points, wherein the first plurality of neighboring points are stored in a third plurality of lists.

In an eighth aspect, a method for storing a bitstream of a point cloud sequence is proposed. The method comprises: determining, for a current point in a current point cloud (PC) sample of the point cloud sequence, a first plurality of neighboring points from points in a second plurality of PC samples of the point cloud sequence; generating the bitstream based on the first plurality of neighboring points; and storing the bitstream in a non-transitory computer-readable recording medium, wherein the first plurality of neighboring points are stored in a third plurality of lists.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 is a block diagram that illustrates an example point cloud coding system that may utilize the techniques of the present disclosure;

FIG. 2 illustrates a block diagram that illustrates an example point cloud encoder, in accordance with some embodiments of the present disclosure;

FIG. 3 illustrates a block diagram that illustrates an example point cloud decoder, in accordance with some embodiments of the present disclosure;

FIG. 4 illustrates a flowchart of a method for point cloud coding in accordance with some embodiments of the present disclosure;

FIG. 5 illustrates a flowchart of another method for point cloud coding in accordance with some embodiments of the present disclosure; and

FIG. 6 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

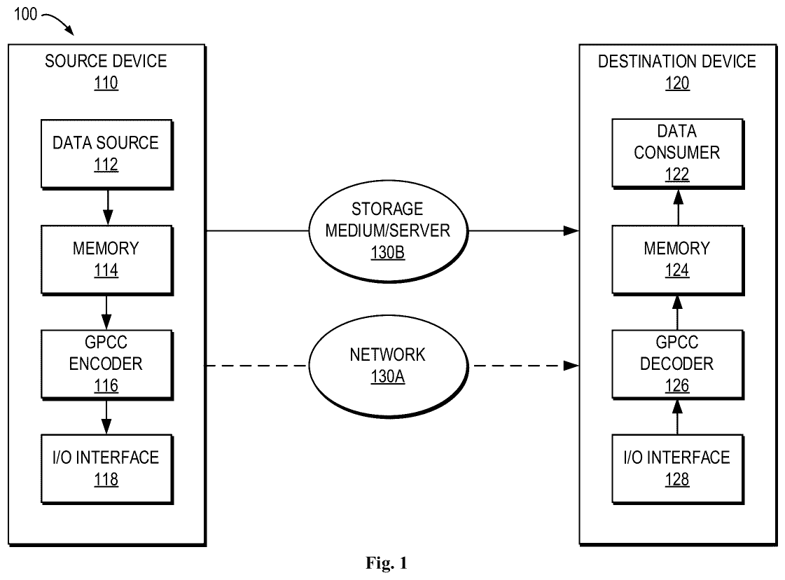

FIG. 1 is a block diagram that illustrates an example point cloud coding system 100 that may utilize the techniques of the present disclosure. As shown, the point cloud coding system 100 may include a source device 110 and a destination device 120. The source device 110 can be also referred to as a point cloud encoding device, and the destination device 120 can be also referred to as a point cloud decoding device. In operation, the source device 110 can be configured to generate encoded point cloud data and the destination device 120 can be configured to decode the encoded point cloud data generated by the source device 110. The techniques of this disclosure are generally directed to coding (encoding and/or decoding) point cloud data, i.e., to support point cloud compression. The coding may be effective in compressing and/or decompressing point cloud data.

Source device 100 and destination device 120 may comprise any of a wide range of devices, including desktop computers, notebook (i.e., laptop) computers, tablet computers, set-top boxes, telephone handsets such as smartphones and mobile phones, televisions, cameras, display devices, digital media players, video gaming consoles, video streaming devices, vehicles (e.g., terrestrial or marine vehicles, spacecraft, aircraft, etc.), robots, LIDAR devices, satellites, extended reality devices, or the like. In some cases, source device 100 and destination device 120 may be equipped for wireless communication.

The source device 100 may include a data source 112, a memory 114, a GPCC encoder 116, and an input/output (I/O) interface 118. The destination device 120 may include an input/output (I/O) interface 128, a GPCC decoder 126, a memory 124, and a data consumer 122. In accordance with this disclosure, GPCC encoder 116 of source device 100 and GPCC decoder 126 of destination device 120 may be configured to apply the techniques of this disclosure related to point cloud coding. Thus, source device 100 represents an example of an encoding device, while destination device 120 represents an example of a decoding device. In other examples, source device 100 and destination device 120 may include other components or arrangements. For example, source device 100 may receive data (e.g., point cloud data) from an internal or external source. Likewise, destination device 120 may interface with an external data consumer, rather than include a data consumer in the same device.

In general, data source 112 represents a source of point cloud data (i.e., raw, unencoded point cloud data) and may provide a sequential series of “frames” of the point cloud data to GPCC encoder 116, which encodes point cloud data for the frames. In some examples, data source 112 generates the point cloud data. Data source 112 of source device 100 may include a point cloud capture device, such as any of a variety of cameras or sensors, e.g., one or more video cameras, an archive containing previously captured point cloud data, a 3D scanner or a light detection and ranging (LIDAR) device, and/or a data feed interface to receive point cloud data from a data content provider. Thus, in some examples, data source 112 may generate the point cloud data based on signals from a LIDAR apparatus. Alternatively or additionally, point cloud data may be computer-generated from scanner, camera, sensor or other data. For example, data source 112 may generate the point cloud data, or produce a combination of live point cloud data, archived point cloud data, and computer-generated point cloud data. In each case, GPCC encoder 116 encodes the captured, pre-captured, or computer-generated point cloud data. GPCC encoder 116 may rearrange frames of the point cloud data from the received order (sometimes referred to as “display order”) into a coding order for coding. GPCC encoder 116 may generate one or more bitstreams including encoded point cloud data. Source device 100 may then output the encoded point cloud data via I/O interface 118 for reception and/or retrieval by, e.g., I/O interface 128 of destination device 120. The encoded point cloud data may be transmitted directly to destination device 120 via the I/O interface 118 through the network 130A. The encoded point cloud data may also be stored onto a storage medium/server 130B for access by destination device 120.

Memory 114 of source device 100 and memory 124 of destination device 120 may represent general purpose memories. In some examples, memory 114 and memory 124 may store raw point cloud data, e.g., raw point cloud data from data source 112 and raw, decoded point cloud data from GPCC decoder 126. Additionally or alternatively, memory 114 and memory 124 may store software instructions executable by, e.g., GPCC encoder 116 and GPCC decoder 126, respectively. Although memory 114 and memory 124 are shown separately from GPCC encoder 116 and GPCC decoder 126 in this example, it should be understood that GPCC encoder 116 and GPCC decoder 126 may also include internal memories for functionally similar or equivalent purposes. Furthermore, memory 114 and memory 124 may store encoded point cloud data, e.g., output from GPCC encoder 116 and input to GPCC decoder 126. In some examples, portions of memory 114 and memory 124 may be allocated as one or more buffers, e.g., to store raw, decoded, and/or encoded point cloud data. For instance, memory 114 and memory 124 may store point cloud data.

I/O interface 118 and I/O interface 128 may represent wireless transmitters/receivers, modems, wired networking components (e.g., Ethernet cards), wireless communication components that operate according to any of a variety of IEEE 802.11 standards, or other physical components. In examples where I/O interface 118 and I/O interface 128 comprise wireless components, I/O interface 118 and I/O interface 128 may be configured to transfer data, such as encoded point cloud data, according to a cellular communication standard, such as 4G, 4G-LTE (Long-Term Evolution), LTE Advanced, 5G, or the like. In some examples where I/O interface 118 comprises a wireless transmitter, I/O interface 118 and I/O interface 128 may be configured to transfer data, such as encoded point cloud data, according to other wireless standards, such as an IEEE 802.11 specification. In some examples, source device 100 and/or destination device 120 may include respective system-on-a-chip (SoC) devices. For example, source device 100 may include an SoC device to perform the functionality attributed to GPCC encoder 116 and/or I/O interface 118, and destination device 120 may include an SoC device to perform the functionality attributed to GPCC decoder 126 and/or I/O interface 128.

The techniques of this disclosure may be applied to encoding and decoding in support of any of a variety of applications, such as communication between autonomous vehicles, communication between scanners, cameras, sensors and processing devices such as local or remote servers, geographic mapping, or other applications.

I/O interface 128 of destination device 120 receives an encoded bitstream from source device 110. The encoded bitstream may include signaling information defined by GPCC encoder 116, which is also used by GPCC decoder 126, such as syntax elements having values that represent a point cloud. Data consumer 122 uses the decoded data. For example, data consumer 122 may use the decoded point cloud data to determine the locations of physical objects. In some examples, data consumer 122 may comprise a display to present imagery based on the point cloud data.

GPCC encoder 116 and GPCC decoder 126 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of GPCC encoder 116 and GPCC decoder 126 may be included in one or more encoders or decoders, either of which may be integrated as part of a combined encoder/decoder (CODEC) in a respective device. A device including GPCC encoder 116 and/or GPCC decoder 126 may comprise one or more integrated circuits, microprocessors, and/or other types of devices.

GPCC encoder 116 and GPCC decoder 126 may operate according to a coding standard, such as video point cloud compression (VPCC) standard or a geometry point cloud compression (GPCC) standard. This disclosure may generally refer to coding (e.g., encoding and decoding) of frames to include the process of encoding or decoding data. An encoded bitstream generally includes a series of values for syntax elements representative of coding decisions (e.g., coding modes).

A point cloud may contain a set of points in a 3D space, and may have attributes associated with the point. The attributes may be color information such as R, G, B or Y, Cb, Cr, or reflectance information, or other attributes. Point clouds may be captured by a variety of cameras or sensors such as LIDAR sensors and 3D scanners and may also be computer-generated. Point cloud data are used in a variety of applications including, but not limited to, construction (modeling), graphics (3D models for visualizing and animation), and the automotive industry (LIDAR sensors used to help in navigation).

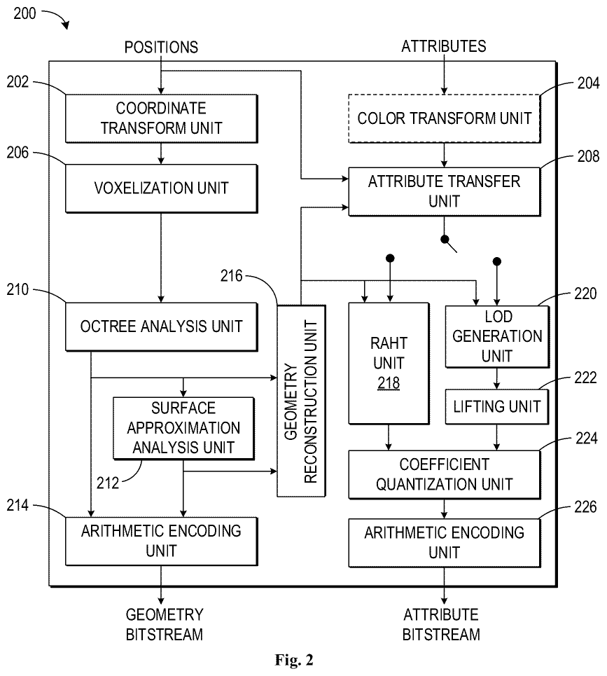

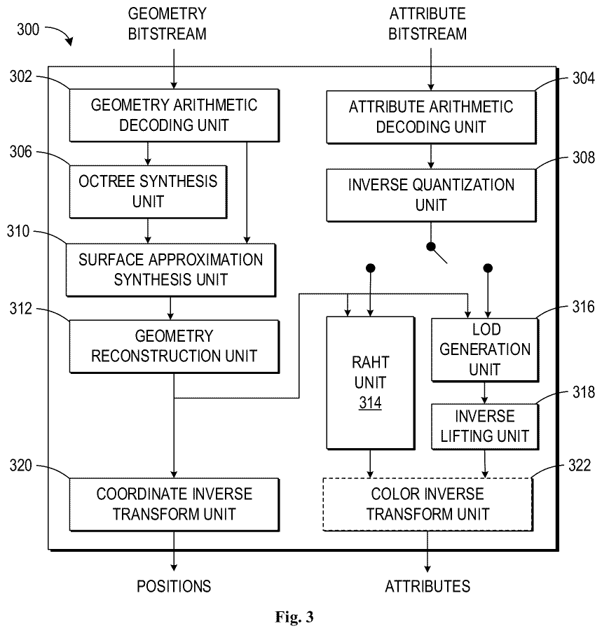

FIG. 2 is a block diagram illustrating an example of a GPCC encoder 200, which may be an example of the GPCC encoder 116 in the system 100 illustrated in FIG. 1, in accordance with some embodiments of the present disclosure. FIG. 3 is a block diagram illustrating an example of a GPCC decoder 300, which may be an example of the GPCC decoder 126 in the system 100 illustrated in FIG. 1, in accordance with some embodiments of the present disclosure.

In both GPCC encoder 200 and GPCC decoder 300, point cloud positions are coded first. Attribute coding depends on the decoded geometry. In FIG. 2 and FIG. 3, the region adaptive hierarchical transform (RAHT) unit 218, surface approximation analysis unit 212, RAHT unit 314 and surface approximation synthesis unit 310 are options typically used for Category 1 data. The level-of-detail (LOD) generation unit 220, lifting unit 222, LOD generation unit 316 and inverse lifting unit 318 are options typically used for Category 3 data. All the other units are common between Categories 1 and 3.

For Category 3 data, the compressed geometry is typically represented as an octree from the root all the way down to a leaf level of individual voxels. For Category 1 data, the compressed geometry is typically represented by a pruned octree (i.e., an octree from the root down to a leaf level of blocks larger than voxels) plus a model that approximates the surface within each leaf of the pruned octrec. In this way, both Category 1 and 3 data share the octree coding mechanism, while Category 1 data may in addition approximate the voxels within each leaf with a surface model. The surface model used is a triangulation comprising 1-10 triangles per block, resulting in a triangle soup. The Category 1 geometry codec is therefore known as the Trisoup geometry codec, while the Category 3 geometry codec is known as the Octree geometry codec.

In the example of FIG. 2, GPCC encoder 200 may include a coordinate transform unit 202, a color transform unit 204, a voxelization unit 206, an attribute transfer unit 208, an octree analysis unit 210, a surface approximation analysis unit 212, an arithmetic encoding unit 214, a geometry reconstruction unit 216, an RAHT unit 218, a LOD generation unit 220, a lifting unit 222, a coefficient quantization unit 224, and an arithmetic encoding unit 226.

As shown in the example of FIG. 2, GPCC encoder 200 may receive a set of positions and a set of attributes. The positions may include coordinates of points in a point cloud. The attributes may include information about points in the point cloud, such as colors associated with points in the point cloud.

Coordinate transform unit 202 may apply a transform to the coordinates of the points to transform the coordinates from an initial domain to a transform domain. This disclosure may refer to the transformed coordinates as transform coordinates. Color transform unit 204 may apply a transform to convert color information of the attributes to a different domain. For example, color transform unit 204 may convert color information from an RGB color space to a YCbCr color space.

Furthermore, in the example of FIG. 2, voxelization unit 206 may voxelize the transform coordinates. Voxelization of the transform coordinates may include quantizing and removing some points of the point cloud. In other words, multiple points of the point cloud may be subsumed within a single “voxel,” which may thereafter be treated in some respects as one point. Furthermore, octrec analysis unit 210 may generate an octree based on the voxelized transform coordinates. Additionally, in the example of FIG. 2, surface approximation analysis unit 212 may analyze the points to potentially determine a surface representation of sets of the points. Arithmetic encoding unit 214 may perform arithmetic encoding on syntax elements representing the information of the octree and/or surfaces determined by surface approximation analysis unit 212. GPCC encoder 200 may output these syntax elements in a geometry bitstream.

Geometry reconstruction unit 216 may reconstruct transform coordinates of points in the point cloud based on the octree, data indicating the surfaces determined by surface approximation analysis unit 212, and/or other information. The number of transform coordinates reconstructed by geometry reconstruction unit 216 may be different from the original number of points of the point cloud because of voxelization and surface approximation. This disclosure may refer to the resulting points as reconstructed points. Attribute transfer unit 208 may transfer attributes of the original points of the point cloud to reconstructed points of the point cloud data.

Furthermore, RAHT unit 218 may apply RAHT coding to the attributes of the reconstructed points. Alternatively or additionally, LOD generation unit 220 and lifting unit 222 may apply LOD processing and lifting, respectively, to the attributes of the reconstructed points. RAHT unit 218 and lifting unit 222 may generate coefficients based on the attributes. Coefficient quantization unit 224 may quantize the coefficients generated by RAHT unit 218 or lifting unit 222. Arithmetic encoding unit 226 may apply arithmetic coding to syntax elements representing the quantized coefficients. GPCC encoder 200 may output these syntax elements in an attribute bitstream.

In the example of FIG. 3, GPCC decoder 300 may include a geometry arithmetic decoding unit 302, an attribute arithmetic decoding unit 304, an octree synthesis unit 306, an inverse quantization unit 308, a surface approximation synthesis unit 310, a geometry reconstruction unit 312, a RAHT unit 314, a LOD generation unit 316, an inverse lifting unit 318, a coordinate inverse transform unit 320, and a color inverse transform unit 322.

GPCC decoder 300 may obtain a geometry bitstream and an attribute bitstream. Geometry arithmetic decoding unit 302 of decoder 300 may apply arithmetic decoding (e.g., CABAC or other type of arithmetic decoding) to syntax elements in the geometry bitstream. Similarly, attribute arithmetic decoding unit 304 may apply arithmetic decoding to syntax elements in attribute bitstream.

Octree synthesis unit 306 may synthesize an octree based on syntax elements parsed from geometry bitstream. In instances where surface approximation is used in geometry bitstream, surface approximation synthesis unit 310 may determine a surface model based on syntax elements parsed from geometry bitstream and based on the octrec.

Furthermore, geometry reconstruction unit 312 may perform a reconstruction to determine coordinates of points in a point cloud. Coordinate inverse transform unit 320 may apply an inverse transform to the reconstructed coordinates to convert the reconstructed coordinates (positions) of the points in the point cloud from a transform domain back into an initial domain.

Additionally, in the example of FIG. 3, inverse quantization unit 308 may inverse quantize attribute values. The attribute values may be based on syntax elements obtained from attribute bitstream (e.g., including syntax elements decoded by attribute arithmetic decoding unit 304).

Depending on how the attribute values are encoded, RAHT unit 314 may perform RAHT coding to determine, based on the inverse quantized attribute values, color values for points of the point cloud. Alternatively, LOD generation unit 316 and inverse lifting unit 318 may determine color values for points of the point cloud using a level of detail-based technique.

Furthermore, in the example of FIG. 3, color inverse transform unit 322 may apply an inverse color transform to the color values. The inverse color transform may be an inverse of a color transform applied by color transform unit 204 of encoder 200. For example, color transform unit 204 may transform color information from an RGB color space to a YCbCr color space. Accordingly, color inverse transform unit 322 may transform color information from the YCbCr color space to the RGB color space.

The various units of FIG. 2 and FIG. 3 are illustrated to assist with understanding the operations performed by encoder 200 and decoder 300. The units may be implemented as fixed-function circuits, programmable circuits, or a combination thereof. Fixed-function circuits refer to circuits that provide particular functionality and are preset on the operations that can be performed. Programmable circuits refer to circuits that can be programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to GPCC or other specific point cloud codecs, the disclosed techniques are applicable to other point cloud coding technologies also. Furthermore, while some embodiments describe point cloud coding steps in detail, it will be understood that corresponding steps decoding that undo the coding will be implemented by a decoder.

### 1. SUMMARY

This disclosure is related to point cloud coding technologies. Specifically, it is related to point cloud attribute prediction in inter prediction. The ideas may be applied individually or in various combination, to any point cloud coding standard or non-standard point cloud codec, e.g., the being-developed Geometry based Point Cloud Compression (G-PCC).

### 2. ABBREVIATIONS

G-PCC Geometry based Point Cloud Compression
MPEG Moving Picture Experts Group
3DG 3D Graphics Coding Group
CFP Call For Proposal
V-PCC Video-based Point Cloud Compression
LOD Level of Detail
CE Core Experiment
EE Exploration Experiment
inter-EM Inter Exploration Model
PC
Point Cloud
Rate-distortion Optimization
RDO

### 3. BACKGROUND

Point cloud coding standards have evolved primarily through the development of the well-known MPEG organization. MPEG, short for Moving Picture Experts Group, is one of the main standardization groups dealing with multimedia. In 2017, the MPEG 3D Graphics Coding group (3DG) published a call for proposals (CFP) document to start to develop point cloud coding standard. The final standard will consist in two classes of solutions. Video-based Point Cloud Compression (V-PCC) is appropriate for point sets with a relatively uniform distribution of points. Geometry-based Point Cloud Compression (G-PCC) is appropriate for more sparse distributions.

To explore the future point cloud coding technologies in G-PCC, Core Experiment (CE) 13.5 and Exploration Experiment (EE) 13.2 were formed to develop inter prediction technologies in G-PCC. Since then, many new inter prediction methods have been adopted by MPEG and put into the reference software named inter Exploration Model (inter-EM).

In one point cloud, there may be geometry information and attribute information. Geometry information is used to describe the geometry locations of the data points. Attribute information is used to record some details of the data points, such as textures, normal vectors, reflections and so on. Point cloud codec can process the various information in different ways. Usually there are many optional tools in the codec to support the coding and decoding of geometry information and attribute information respectively.

### 3.1 ATTRIBUTE INTRA PREDICTION

In G-PCC, two attribute coding methods have been proposed by using the geometry information to perform the attribute intra prediction.

### 3.1.1 PREDICTING TRANSFORM

Predicting transform is an interpolation-based hierarchical nearest neighbors prediction method, which is typically used for sparse point cloud content. Firstly, a level of detail (LOD) structure is generated. Secondly, the nearest neighbors are searched based on the LOD structure. Then, the attribute pre diction is performed based on the search results.

### 3.1.1.1 LOD GENERATION

In the LOD generation process, the geometry information is leveraged to build a hierarchical structure of the point cloud, which defines a set of “level of details”. The hierarchical structure is exploited to predict attributes efficiently. It also makes it possible to provide advanced functionalities such as progressive transmission and scalable rendering. The LOD generation process re-organizes the point cloud points into a set of refine level (points set) R₀, R₁, . . . , R_{L-1} according to the user-defined parameter L which indicates LOD number. Then the attribute of point cloud points are encoded from R₀ to R_{L-1}. The level of detail l, LODₗ, can be obtained by taking the union of the refinement levels R₀, R₁, . . . , Rₗ:

$${LOD}_{l} = {R}_{0} ⋃ {R}_{1} ⋃ … ⋃ {R}_{l} \qquad ( 3 - 1 )$$

### 3.1.1.2 NEAREST NEIGHBORS SEARCH CONSIDERING POINT DISTRIBUTION

In G-PCC, two neighbor lists, list1 and list2, are built to search 3 approximately nearest neighbors of the current point. List1 contains 3 approximately nearest neighbors which are obtained by a LOD based approximately nearest neighbors search algorithm. List2 contains 3 points that are dropped out when updating list1.

Considering the point distribution information, the concept of strict opposite and loose opposite are defined. According to the relative position with the current point (x, y, z), every nearest neighbor point (xₙ>yₙ, Zₙ) is assigned to a direction index dirIdx. According to the direction index dirIdx, strict opposite and loose opposite are defined as table 3-1.

TABLE 3-1
the definition strict opposite and loose
opposite according direction index dirIdx

| strict opposite | loose opposite |
|---|---|
| 0 ↔ 7 | 0 ↔ 3, 5, 6 |
| 1 ↔ 6 | 1 ↔ 2, 4, 7 |
| 2 ↔ 5 | 2 ↔ 1, 4, 7 |
| 3 ↔ 4 | 3 ↔ 0, 5, 6 |
| — | 4 ↔ 1, 2, 7 |
| — | 5 ↔ 0, 3, 6 |
| — | 6 ↔ 0, 3, 5 |
| — | 7 ↔ 1, 2, 4 |

The final neighbor list is generated by updating list1 using points in list2 with a strict opposite eligibility check and a loose opposite eligibility check. Note that the point number of final list1 may be less than 3 because there are not enough neighbors, and a neighbor pruning process is performed.

### 3.1.1.3 ATTRIBUTE PREDICTION

After obtaining list1, multiple predictor candidates are created based on list1. Each predictor candidate is assigned with one index. Then, the variability of the attributes of the points in list1 is computed. If the variability is less than a threshold, the weighted average value is used to predict the attribute of the current point. Otherwise, the best predictor is selected by applying a rate-distortion optimization (RDO) procedure.

### 3.1.2 LIFTING TRANSFORM

The lifting transform is typically used for dense point cloud content and is built on top of the predicting transform method. The main difference between lifting transform and prediction transform is the update operator and adaptive quantization strategy. In lifting transform, each point is associated with an influence weight value. Points in lower LODs are used more often and assigned with higher weight values. The influence weight is used in the quantization processes.

### 3.2 ATTRIBUTE INTER PREDICTION

In inter-EM, some inter prediction tools have been proposed to perform attribute inter coding. There is one list1 to store the nearest neighbors in current frame and the previous one frame. The attributes of the points in the list are used to generate the predictor candidates and get the predicted value of the current point in the similar way as in intra frame coding.

Firstly, the points in the current frame and the reference frame are reordered based on the Morton code. Each point is associated with one Morton index to show the Morton order.

Then, for each point, the nearest neighbors search is performed in the current frame and the reference frame. There is one parameter, Search_Range, to control the search range.
a) In the current frame, the previous Search_Range points of the current point in Morton order are traversed.
b) In the reference frame, the search center is the point with the same Morton index in the reference frame. The previous Search_Range points before the search center, the following Search_Range points after the search center and the search center point are searched.

The nearest neighbors search is based on the Euclidean distance from the searched point to the current point. 3 nearest points are selected and stored in the list1. It should be noted that the weights of the points from the reference frame should be lower than those points from the current frame. Finally, multiple predictor candidates are created based on the list1 and the predicted attribute value is generated in the similar way with the intra coding.

### 4. PROBLEMS

The existing designs for point cloud attribute inter prediction have the following problems:
1. In current inter-EM, the search center in the reference frame is the point with the same Morton index. However, there is no strict correspondence between the reordered points in the current frame and the reference frame. In some cases, the points with the same Morton index have very different geometric positions which leads to inaccurate search and prediction results.
2. In current inter-EM, the nearest search is performed based on the Euclidean distance. The calculation of Euclidean distance has high complexity which affects the overall complexity of the encoding and decoding.
3. In current inter-EM, the search ranges in the current frame and reference frame are the same. However, the points in the current frame and points in difference frames have different effects on the current point. Using the same search range will limit the prediction efficiency.

### 5. DETAILED SOLUTIONS

To solve the above problems and some other problems not mentioned, methods as summarized below are disclosed. The solutions should be considered as examples to explain the general concepts and should not be interpreted in a narrow way. Furthermore, these solutions can be applied individually or combined in any manner.

In the following description, list1 may be the list which stores the nearest neighbors.
1) It is proposed that at least one search center may be derived for the nearest neighbor search in attribute inter prediction.
   a. In one example, the nearest neighbors search may be performed within a given frame to be searched.
      i. In one example, the given frame to be searched may be the current frame.
      ii. In one example, the given frame to be searched may be another frame.
      iii. In one example, the given frame to be searched may be a reference frame of the current frame.
   b. In one example, the points in a given frame to be searched may be reordered before the nearest neighbor search.
      i. In one example, the reordering may be performed based on the Morton codes, Hilbert codes or other converted codes of the points.
      ii. In one example, the reordering may be performed based on the polar coordinates of the points.
      iii. In one example, the reordering may be performed based on the spherical coordinates of the points.
      iv. In one example, the reordering may be performed based on the cylindrical coordinates of the points.
      v. In one example, the reordering may be performed based on the scanning order of the radar.
      vi. In one example, the searching will be conducted following an order (which may be reordered) of the points.
   c. In one example, there may be one search center for a given frame to be searched.
      i. In one example, the previous points before the search center in the reordered order and the search center may be searched.
      ii. In one example, the following points after the search center in the reordered order and the search center may be searched.
      iii. In one example, the previous points before the search center in the reordered order, the search center and the following points after the search center in the reordered order may be searched.
   d. In one example, the search center may be an approximate nearest point in geometric location in the frame to be searched.
      i. In one example, the search center may be selected from all points or partial points in the frame to be searched.
      ii. In one example, the search center may be the point with the nearest distance from the current point.
         (1) The distance may be the Euclidean distance, the Manhattan distance, the Chebyshev distance and so on.
      iii. In one example, the search center may be the point with the approximate nearest distance from the current point.
         (1) The search center may be selected from partial points in the frame to be searched.
         (2) The distance may be the Euclidean distance, the Manhattan distance, the Chebyshev distance and so on.
      iv. In one example, the search center may be the point with the nearest distance on the converted codes from the current point.
         (1) The distance may be the difference on the converted codes.
         (2) The converted codes may be the Morton codes, Hilbert codes and so on.
      v. In one example, the search center may be the point with the approximate nearest distance on the converted codes from the current point.
         (1) The search center may be selected from partial points in the frame to be searched.
         (2) In one example, the partial points may be the points whose converted codes are greater than the current point converted code.
         (3) In one example, the partial points may be the points whose converted codes are less than the current point converted code.
         (4) The distance may be the difference on the converted codes.
         (5) The converted codes may be the Morton codes, Hilbert codes and so on.
   e. In one example, multiple (such as N) search centers may be derived.
      i. Alternatively, furthermore, the search may be conducted from one or multiple of the search centers.
      ii. In one example, the N search centers may be the N points with the N nearest distances from the current point.
      iii. In one example, the N search centers may be the N points with the N nearest distances on the converted codes from the current point.
2) It is proposed to use different search ranges in different directions and/or different frames.
   a. In one example, there may be at least one search range for one frame to be searched.
      i. In one example, there may be one search range to indicate the number of points before the search center which need to be searched.
      ii. In one example, there may be one search range to indicate the number of points after the search center which need to be searched.
      iii. In one example, there may be one search range to indicate both the number of points before the search center and the number of points after the search center which need to be searched.
   b. In one example, there may be different search ranges for the current frame and the reference frame(s).
3) It is proposed to signal the search range to the decoder by coding an indication to indicate the search range.
   a. In one example, at least one indication may be signalled to the decoder to indicate the search ranges.
      i. In one example, the indication may be a pre-defined signal when the codec performs the nearest neighbors search on all points.
      ii. In one example, the indication may be selected from some pre-defined signals when the search range is selected from some pre-defined search ranges.
      iii. In one example, the indication may be the value of the search range.
      iv. In one example, the indication may be the pre-defined mathematical conversion (such as logarithm, square root and so on) of the search range.
   b. In one example, the indication may be coded with fixed-length coding, unary coding, truncated unary coding, etc. al.
   c. In one example, the indication may be coded in a predictive way.
4) Different geometric distances may be used for the nearest neighbors search and neighbor weight generation in attribute inter prediction.
a. In one example, at least one points may be stored in list1 by performing nearest neighbors search in the current frame and the reference frame.
   i. In one example, the selected points may be the points with the closest geometric distance (such as the Euclidean distance, the Manhattan distance, the Chebyshev distance and so on) from the current point.
      ii. In one example, the selected points may be from the searched points which are defined by the search center and search range.
   b. In one example, the geometric distance of each point in list1 may be used for neighbor weights generation.
   c. In one example, the process of nearest neighbor search and neighbor weights generation may use different geometric distances.
      i. In one example, the Manhattan distance of each searched point may be used for nearest neighbors search and the Euclidean distance of each point in list1 may be used for neighbor weight generation.
5) It is proposed to apply motion compensation to the reference frame before attribute inter prediction.
   a. In one example, there may be motion compensation for the reference frame.
   b. In one example, motion compensation may be applied to the reference frame before attribute inter prediction.
   c. In one example, the reference frame with motion compensation may be used in the attribute inter prediction.
   d. In one example, the reference frame without motion compensation may be used in the attribute inter prediction.
   e. In one example, the indication to indicate whether motion compensation is applied may be signalled to the decoder.
      i. In one example, the indication may be coded with fixed-length coding, unary coding, truncated unary coding, etc. al.

ii. In one example, the indication may be coded in a predictive way.
6) Points in the different LODs of the reference frame may be searched in attribute inter prediction.
   a. In one example, the points in the reference frame may be divided into one or multiple LODs.
   b. In one example, the points in the current frame may be divided into one or multiple LODs.
   c. In one example, there may be one LOD level referring the LOD for each point.
   d. In one example, for current point, the points with the same LOD level in the reference frame may be searched to perform the nearest neighbor search.
   e. In one example, for current point, the points with the lower LOD level in the reference frame may be searched to perform the nearest neighbor search.
   f. In one example, for current point, the points with the higher LOD level in the reference frame may be searched to perform the nearest neighbor search.
   g. In one example, an indication to indicate whether the points in all LODs are searched may be signalled to the decoder.
      i. In one example, the indication may be coded with fixed-length coding, unary coding, truncated unary coding, etc. al.
      ii. In one example, the indication may be coded in a predictive way.
   h. In one example, an indication to indicate whether only the points in the same LOD are searched may be signalled to the decoder.
      i. In one example, the indication may be conditionally signalled, e.g., according to whether the points in all LODs are searched.
      ii. In one example, the indication may be coded with fixed-length coding, unary coding, truncated unary coding, etc. al.
      iii. In one example, the indication may be coded in a predictive way.
7) It is proposed to use multiple lists to store the search results in different frames and generate the predictor list by combining all lists.
   a. In one example, there may be a first list (such as list1) to store the search results in the current frame.
   b. In one example, there may be a second list (such as list2) to store the search results in each reference frame.
   c. In one example, the nearest neighbor search in the current frame may only change the list1.
   d. In one example, the nearest neighbor search in one reference frame may only change the corresponding list.
   e. In one example, the information of the points in all lists may be used to generate the predictor list.
8) The above mentioned ‘frame’ may be replaced by other processing unit, e.g., a sub-region within a frame.
9) The above methods may be also applicable to other coding modules in G-PCC or other search methods in addition to the nearest neighbour search method.

### 6. EMBODIMENTS

1) This embodiment describes an example of how to use Manhattan distance to perform nearest neighbor search in attribute inter prediction. In this example, the search center in the reference frame is set to the point with the closest Morton code. The search range for the current frame and the reference frame are both set to 128.

For each frame, the reference frame is the previous one frame and the attribute inter prediction is performed at the encoder and the decoder.

Firstly, the points in the current frame and the reference frame are reordered. The Morton code of each point is calculated and the points in one frame are reordered based on the Morton code order.

Secondly, for each point in the current frame, 3 approximate nearest neighbors in the current frame and the reference frame are searched and stored in list1. There are 3 flags to indicate whether the nearest neighbor is from the current frame.
a. The search center for the current frame is the current point. The previous 128 points before the search center in Morton code order are traversed. At most 3 points with the closest Manhattan distance are selected from the traversed points. The position, flag and index of each point in list1 are recorded. The Manhattan distance d of two points (x₁, y₁, Z₁) and (x₂, y₂, Z₂) is computed as the following formula:

$$d = \vert {x}_{1} - {x}_{2} \vert + \vert {y}_{1} - {y}_{2} \vert + \vert {z}_{1} - {z}_{2} \vert , \qquad ( 6 - 1 )$$

b. The search center for the reference frame is the point with the closest Morton code to the current point in the reference frame. The previous 128 points before the search center in Morton code order, the following 128 points after the search center in Morton code order and the search center are traversed. If the Manhattan distance of the traversed point is closer than the point in list1, the list1 is updated by inserting the traversed points in list1 and removing the point with the highest Manhattan distance in list1. The position, flag and index of each point in list1 are recorded.

Thirdly, for each point in the current frame, the predictors are generated based on the information of the points in list1 and the predicted value is generated.
a. There is one weight value for each point in list1. The calculated distance for each point in list1 is calculated based on the Euclidean distance from the point to the current point. The calculated distance for point from the reference frame should be added 1. The weight value for each point in list1 is the reciprocal of the calculated distance. The Euclidean distance d of two points (x₁, y₁, Z₁) and (x₂, y₂, Z₂) is computed as the following formula:

$$d = \sqrt{{( {x}_{1} - {x}_{2} )}^{2} + {( {y}_{1} - {y}_{2} )}^{2} + {( {z}_{1} - {z}_{2} )}^{2}} , \qquad ( 6 - 2 )$$

b. The attribute for each point in list1 is obtained based on the index.
c. The variability of the attributes of the points in list1 is computed.
d. If the variability is less than a threshold, the weighted average value is used to predict the attribute of the current point.
e. Otherwise, the best predictor is selected by applying a RDO procedure. The candidate list of predictors includes the weighted average value and the attribute values of the points in list1. And the result of RDO process is signalled to the decoder. At the decoder, the predicted value will be generated based on the signalled RDO result.

Finally, for each point in the current frame, the residual between the attribute of the current frame and the predicted attribute value is coded and signalled to the decoder.

More details of the embodiments of the present disclosure will be described below which are related to optimized inter prediction for point cloud attribute coding based on the nearest neighbor search.

As used herein, the term “point cloud sequence” may refer to a sequence of one or more point clouds. The term “frame” may refer to a point cloud in a point cloud sequence. The term “PC sample” may refer to a unit that performs coding in the point cloud sequence coding, such as a point cloud frame, a sub-region within a point cloud frame, a picture, a slice, a tile, a subpicture, a node, a point, or other unit that contains one or more nodes or points.

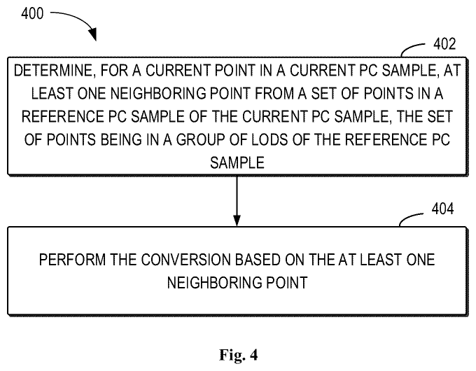

FIG. 4 illustrates a flowchart of a method 400 for point cloud coding in accordance with some embodiments of the present disclosure. The method 400 may be implemented during a conversion between a current PC sample of a point cloud sequence and a bitstream of the point cloud sequence. As shown in FIG. 4, the method 400 starts at 402, where for a current point in a current PC sample, at least one neighboring point is determined from a set of points in a reference PC sample of the current PC sample. The set of points are in a group of level of details (LODs) of the reference PC sample. By way of example, the at least one neighboring point may be at least one nearest neighbor of the current point. The nearest neighbor search may be performed on points in the same LOD as the current point and the nearest neighbor search may be performed on points in a LOD lower than the current point, so as to obtain the at least one nearest neighbor.

At 404, the conversion is performed based on the at least one neighboring point. For example, the attribute value of the current point may be predicted by calculating a weighted average of attribute value of the at least one neighboring point. The conversion may be performed based on the predicted attribute value. In some embodiments, the conversion may include encoding the current PC sample into the bitstream. Additionally or alternatively, the conversion may include decoding the current PC sample from the bitstream. It should be understood that the above examples are described merely for purpose of description. The scope of the present disclosure is not limited in this respect.

In view of the above, points in a group of LODs of the reference PC sample are searched to obtain the neighboring point of the current point. Compared with the conventional solution where only the points in the same LOD as the current point are searched, the proposed method can advantageously improve the accuracy of the nearest neighbor search and the attribute inter prediction.

In some embodiments, points in the reference PC sample may be divided into a plurality of LODs, and the plurality of LODs may comprise the group of LODs. Additionally or alternatively, points in the current PC sample may be divided into one or more LODs.

In some embodiments, the at least one neighboring point may be determined at 402 by performing nearest neighbor search on the set of points. In some embodiments, for each point in the reference PC sample and/or the current PC sample, there may be one LOD level indicating a refinement list of one of the plurality of LODs. In one example, the set of points may comprise points at the same LOD level as the current point. In another example, the set of points may comprise points at a LOD level lower than the current point. In a further example, the set of points may comprise points at a LOD level higher than the current point. It should be understood that the above illustrations are described merely for purpose of description. The scope of the present disclosure is not limited in this respect.

In some embodiments, a first indication indicating whether the nearest neighbor search is performed on points in all of LODs of the reference PC sample may be comprised in the bitstream. For example, the first indication may be signaled to the decoder. In one example, the first indication may be coded with fixed-length coding. Alternatively, the first indication may be coded with unary coding. In a further example, the first indication may be coded with truncated unary coding. In yet another example, the first indication may be coded in a predictive way.

Additionally or alternatively, a second indication indicating whether the nearest neighbor search is performed on points in the same LOD of the reference PC sample as the current point may be comprised in the bitstream. The second indication may be conditionally signaled. In one example, the second indication may be comprised in the bitstream based on whether the nearest neighbor search may be performed on points in all of LODs of the reference PC sample. In one example, the second indication may be coded with fixed-length coding. Alternatively, the second indication may be coded with unary coding. In a further example, the second indication may be coded with truncated unary coding. In yet another example, the second indication may be coded in a predictive way.

In some embodiments, the at least one neighboring point may be determined at 402 based on a first geometric distance. At 404, at least one weight associated with the at least one neighboring point may be determined based on a second geometric distance, and the conversion may be performed based on the at least one weight and the at least one neighboring point. The second geometric distance is different from the first geometric distance. In some examples, the first geometric distance may be one of the following: Euclidean distance, Manhattan distance, or Chebyshev distance. In one example, the first geometric distance may be Manhattan distance, and the second geometric distance may be Euclidean distance. Alternatively, the second geometric distance may be determined based on the first geometric distance. It should be understood that the above examples are described merely for purpose of description. The scope of the present disclosure is not limited in this respect.

In some embodiments, the at least one neighboring point may be stored in a list. In some embodiments, the at least one neighboring point may comprise a target point. A first geometric distance between the target point and the current point may be the smallest among first geometric distances between the current point and respective points in the set of points. In some embodiments, the set of points may be defined by a search center and a search range.

In some embodiments, at 404, a compensated reference frame may be obtained by applying motion compensation on the reference frame. Moreover, a predicted attribute value of the current point may be determined based on the at least one neighboring point and the compensated reference frame, and the conversion may be performed based on the predicted attribute value. That is, motion compensation may be applied to the reference frame before attribute inter prediction.

Alternatively, at 404, a predicted attribute value of the current point may be determined based on the at least one neighboring point and the reference frame, and the conversion may be performed based on the predicted attribute value. That is, the reference frame without motion compensation may be used in the attribute inter prediction.

In some embodiments, a third indication indicating whether motion compensation is applied on the reference frame may be comprised in the bitstream. In one example, the third indication may be coded with fixed-length coding. Alternatively, the third indication may be coded with unary coding. In a further example, the third indication may be coded with truncated unary coding. In yet another example, the third indication may be coded in a predictive way.

According to embodiments of the present disclosure, a non-transitory computer-readable recording medium is proposed. A bitstream of a point cloud sequence is stored in the non-transitory computer-readable recording medium. The bitstream can be generated by a method performed by a point cloud processing apparatus. According to the method, for a current point in a current PC sample, at least one neighboring point is determined from a set of points in a reference PC sample of the current PC sample. The set of points are in a group of level of details (LODs) of the reference PC sample. Moreover, the bitstream is generated based on the at least one neighboring point.

According to embodiments of the present disclosure, a method for storing a bitstream of a point cloud sequence is proposed. In the method, for a current point in a current PC sample, at least one neighboring point is determined from a set of points in a reference PC sample of the current PC sample. The set of points are in a group of level of details (LODs) of the reference PC sample. Moreover, the bitstream is generated based on the at least one neighboring point. The bitstream is stored in the non-transitory computer-readable recording medium.

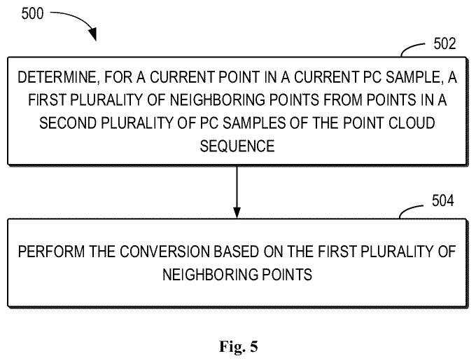

FIG. 5 illustrates a flowchart of another method 500 for point cloud coding in accordance with some embodiments of the present disclosure. The method 500 may be implemented during a conversion between a current PC sample of a point cloud sequence and a bitstream of the point cloud sequence. As shown in FIG. 5, the method 500 starts at 502, where for a current point in a current PC sample, a first plurality of neighboring points are determined from points in a second plurality of PC samples of the point cloud sequence. The first plurality of neighboring points are stored in a third plurality of lists. By way of example, the first plurality of neighboring point may comprise at least one nearest neighbor of the current point. The nearest neighbor search may be performed on points of the current PC sample, and the search results may be store in a first list. Furthermore, the nearest neighbor search may be performed on points of a reference PC sample of the current PC sample, and the search results may be store in a second list different from the second list.

At 404, the conversion is performed based on the first plurality of neighboring points. For example, the attribute value of the current point may be predicted by calculating a weighted average of attribute value of the first plurality of neighboring points. The conversion may be performed based on the predicted attribute value. In some embodiments, the conversion may include encoding the current PC sample into the bitstream. Additionally or alternatively, the conversion may include decoding the current PC sample from the bitstream. It should be understood that the above examples are described merely for purpose of description. The scope of the present disclosure is not limited in this respect.

In view of the above, the plurality of neighboring points of the current point are stored in more than one list. Compared with the conventional solution where neighboring points are stored in only one list, the proposed method can advantageously improve the efficiency of the nearest neighbor search and the attribute inter prediction.

In some embodiments, a first set of neighboring points in the first plurality of neighboring points may be stored in a first list of the third plurality of lists, while the first set of neighboring points are determined from points in the current PC sample. That is, there is a first list to store search results in the current PC sample. Additionally or alternatively, a second set of neighboring points in the first plurality of neighboring points may be stored in a second list of the third plurality of lists, while the second set of neighboring points are determined from points in a reference PC sample of the current PC sample. The second list may be different from the first list. That is, there is a second list to store search results in the reference PC sample.

In some embodiments, during the determination at 502, a first neighboring point of the first plurality of neighboring points may be determined from points in the current PC sample, and the first neighboring point may be stored in the first list. For example, the nearest neighbor search in the current PC sample may only change the first list. Additionally or alternatively, during the determination at 502, a second neighboring point of the first plurality of neighboring points may be determined from points in the reference PC sample, and the second neighboring point may be stored in the second list. For example, the nearest neighbor search in one reference frame may only change the corresponding list.

In some embodiments, at 504, at least one predicted attribute value of the current point may be determined based on neighboring points stored in the third plurality of lists, and the conversion may be performed based on the at least one predicted attribute value. That is, the information of points stored in all of lists may be used to predict the attribute value of the current point.

In some embodiments, the methods 400 and 500 may be applicable to other coding process in geometry based point cloud compression (GPCC) or a search process other than nearest neighbor search. For example, the methods 400 and 500 may be implemented in other coding modules in GPCC.

According to embodiments of the present disclosure, a non-transitory computer-readable recording medium is proposed. A bitstream of a point cloud sequence is stored in the non-transitory computer-readable recording medium. The bitstream can be generated by a method performed by a point cloud processing apparatus. According to the method, for a current point in a current PC sample, a first plurality of neighboring points are determined from points in a second plurality of PC samples of the point cloud sequence. The first plurality of neighboring points are stored in a third plurality of lists. Moreover, the bitstream is generated based on the first plurality of neighboring points.

According to embodiments of the present disclosure, a method for storing a bitstream of a point cloud sequence is proposed. In the method, for a current point in a current PC sample, a first plurality of neighboring points are determined from points in a second plurality of PC samples of the point cloud sequence. The first plurality of neighboring points are stored in a third plurality of lists. Moreover, the bitstream is generated based on the first plurality of neighboring points. The bitstream is stored in the non-transitory computer-readable recording medium.

Implementations of the present disclosure can be described in view of the following clauses, the features of which can be combined in any reasonable manner.

Clause 1. A method for point cloud coding, comprising: determining, for a current point in a current point cloud (PC) sample of a point cloud sequence during a conversion between the current PC sample and a bitstream of the point cloud sequence, at least one neighboring point from a set of points in a reference PC sample of the current PC sample, the set of points being in a group of level of details (LODs) of the reference PC sample; and performing the conversion based on the at least one neighboring point.

Clause 2. The method of clause 1, wherein points in the reference PC sample are divided into a plurality of LODs, the plurality of LODs comprise the group of LODs.

Clause 3. The method of any of clauses 1-2, wherein points in the current PC sample are divided into one or more LODs.

Clause 4. The method of any of clauses 2-3, wherein for each point in the reference PC sample, there is one LOD level indicating a refinement list of one of the plurality of LODs.

Clause 5. The method of clause 4, wherein determining the at least one neighboring point comprises: determining the at least one neighboring point by performing nearest neighbor search on the set of points.

Clause 6. The method of clause 5, wherein the set of points comprise points at the same LOD level as the current point.

Clause 7. The method of clause 5, wherein the set of points comprise points at a LOD level lower than the current point.

Clause 8. The method of clause 5, wherein the set of points comprise points at a LOD level higher than the current point.

Clause 9. The method of clause 5, wherein a first indication indicating whether the nearest neighbor search is performed on points in all of LODs of the reference PC sample is comprised in the bitstream.

Clause 10. The method of clause 9, wherein the first indication is coded with one of the following: fixed-length coding, unary coding, or truncated unary coding.

Clause 11. The method of clause 9, wherein the first indication is coded in a predictive way.

Clause 12. The method of clause 5, wherein a second indication indicating whether the nearest neighbor search is performed on points in the same LOD of the reference PC sample as the current point is comprised in the bitstream.

Clause 13. The method of clause 12, wherein the second indication is comprised in the bitstream based on whether the nearest neighbor search is performed on points in all of LODs of the reference PC sample.

Clause 14. The method of clause 12, wherein the second indication is coded with one of the following: fixed-length coding, unary coding, or truncated unary coding.

Clause 15. The method of clause 12, wherein the second indication is coded in a predictive way.

Clause 16. The method of any of clauses 1-15, wherein the at least one neighboring point is determined based on a first geometric distance, performing the conversion comprises: determining at least one weight associated with the at least one neighboring point based on a second geometric distance, the second geometric distance being different from the first geometric distance; and performing the conversion based on the at least one weight and the at least one neighboring point.

Clause 17. The method of clause 16, wherein the at least one neighboring point is stored in a list.

Clause 18. The method of any of clauses 16-17, wherein the at least one neighboring point comprises a target point, a first geometric distance between the target point and the current point being the smallest among first geometric distances between the current point and respective points in the set of points.

Clause 19. The method of any of clauses 16-18, wherein the first geometric distance is one of the following: Euclidean distance, Manhattan distance, or Chebyshev distance.

Clause 20. The method of any of clauses 16-19, wherein the set of points are defined by a search center and a search range.

Clause 21. The method of any of clauses 16-20, wherein the second geometric distance is determined based on the first geometric distance.

Clause 22. The method of any of clauses 16-20, wherein the first geometric distance is Manhattan distance, and the second geometric distance is Euclidean distance.

Clause 23. The method of any of clauses 1-15, wherein performing the conversion comprises: obtaining a compensated reference frame by applying motion compensation on the reference frame; determining a predicted attribute value of the current point based on the at least one neighboring point and the compensated reference frame; and performing the conversion based on the predicted attribute value.

Clause 24. The method of any of clauses 1-15, wherein performing the conversion comprises: determining a predicted attribute value of the current point based on the at least one neighboring point and the reference frame; and performing the conversion based on the predicted attribute value.

Clause 25. The method of any of clauses 1-15, wherein a third indication indicating whether motion compensation is applied on the reference frame is comprised in the bitstream.

Clause 26. The method of clause 25, wherein the third indication is coded with one of the following: fixed-length coding, unary coding, or truncated unary coding.

Clause 27. The method of clause 25, wherein the third indication is coded in a predictive way.

Clause 28. The method of any of clause 1-27, wherein the at least one neighboring point comprises at least one nearest neighbor of the current point.

Clause 29. A method for point cloud coding, comprising: determining, for a current point in a current point cloud (PC) sample of a point cloud sequence during a conversion between the current PC sample and a bitstream of the point cloud sequence, a first plurality of neighboring points from points in a second plurality of PC samples of the point cloud sequence; and performing the conversion based on the first plurality of neighboring points, wherein the first plurality of neighboring points are stored in a third plurality of lists.

Clause 30. The method of clause 29, wherein a first set of neighboring points in the first plurality of neighboring points are stored in a first list of the third plurality of lists, the first set of neighboring points being determined from points in the current PC sample.

Clause 31. The method of clause 30, wherein a second set of neighboring points in the first plurality of neighboring points are stored in a second list of the third plurality of lists, the second set of neighboring points being determined from points in a reference PC sample of the current PC sample, the second list being different from the first list.

Clause 32. The method of any of clauses 30-31, wherein determining the first plurality of neighboring points comprises: determining a first neighboring point of the first plurality of neighboring points from points in the current PC sample; and storing the first neighboring point in the first list.

Clause 33. The method of clause 31, wherein determining the first plurality of neighboring points comprises: determining a second neighboring point of the first plurality of neighboring points from points in the reference PC sample; and storing the second neighboring point in the second list.

Clause 34. The method of any of clauses 29-33, wherein performing the conversion comprises: determining at least one predicted attribute value of the current point based on neighboring points stored in the third plurality of lists; and performing the conversion based on the at least one predicted attribute value.

Clause 35. The method of any of clauses 29-34, wherein the first plurality of neighboring point comprises at least one nearest neighbor of the current point.

Clause 36. The method of any of clauses 1-35, wherein the current PC sample is a point cloud frame in the point cloud sequence or a sub-region within a point cloud frame in the point cloud sequence.

Clause 37. The method of any of clauses 1-36, wherein the method is applicable to other coding process in geometry based point cloud compression (GPCC) or a search process other than nearest neighbor search.

Clause 38. The method of any of clauses 1-37, wherein the conversion includes encoding the current PC sample into the bitstream.

Clause 39. The method of any of clauses 1-37, wherein the conversion includes decoding the current PC sample from the bitstream.

Clause 40. An apparatus for processing point cloud data comprising a processor and a non-transitory memory with instructions thereon, wherein the instructions upon execution by the processor, cause the processor to perform a method in accordance with any of clauses 1-39.

Clause 41. A non-transitory computer-readable storage medium storing instructions that cause a processor to perform a method in accordance with any of clauses 1-39.

Clause 42. A non-transitory computer-readable recording medium storing a bitstream of a point cloud sequence which is generated by a method performed by a point cloud processing apparatus, wherein the method comprises: determining, for a current point in a current point cloud (PC) sample of the point cloud sequence, at least one neighboring point from a set of points in a reference PC sample of the current PC sample, the set of points being in a group of level of details (LODs) of the reference PC sample; and generating the bitstream based on the at least one neighboring point.

Clause 43. A method for storing a bitstream of a point cloud sequence, comprising: determining, for a current point in a current point cloud (PC) sample of the point cloud sequence, at least one neighboring point from a set of points in a reference PC sample of the current PC sample, the set of points being in a group of level of details (LODs) of the reference PC sample; generating the bitstream based on the at least one neighboring point; and storing the bitstream in a non-transitory computer-readable recording medium.

Clause 44. A non-transitory computer-readable recording medium storing a bitstream of a point cloud sequence which is generated by a method performed by a point cloud processing apparatus, wherein the method comprises: determining, for a current point in a current point cloud (PC) sample of the point cloud sequence, a first plurality of neighboring points from points in a second plurality of PC samples of the point cloud sequence; and generating the bitstream based on the first plurality of neighboring points, wherein the first plurality of neighboring points are stored in a third plurality of lists.

Clause 45. A method for storing a bitstream of a point cloud sequence, comprising: determining, for a current point in a current point cloud (PC) sample of the point cloud sequence, a first plurality of neighboring points from points in a second plurality of PC samples of the point cloud sequence; generating the bitstream based on the first plurality of neighboring points; and storing the bitstream in a non-transitory computer-readable recording medium, wherein the first plurality of neighboring points are stored in a third plurality of lists.

### Example Device

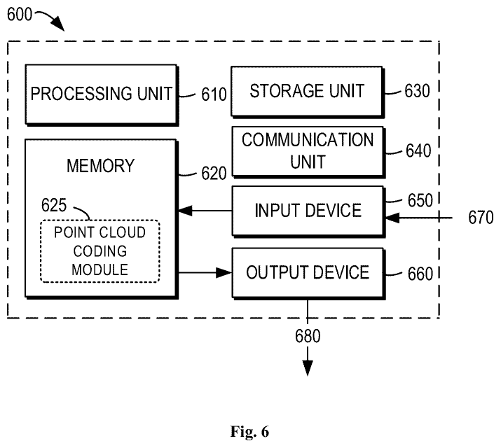

FIG. 6 illustrates a block diagram of a computing device 600 in which various embodiments of the present disclosure can be implemented. The computing device 600 may be implemented as or included in the source device 110 (or the GPCC encoder 116 or 200) or the destination device 120 (or the GPCC decoder 126 or 300).

It would be appreciated that the computing device 600 shown in FIG. 6 is merely for purpose of illustration, without suggesting any limitation to the functions and scopes of the embodiments of the present disclosure in any manner.

As shown in FIG. 6, the computing device 600 includes a general-purpose computing device 600. The computing device 600 may at least comprise one or more processors or processing units 610, a memory 620, a storage unit 630, one or more communication units 640, one or more input devices 650, and one or more output devices 660.

In some embodiments, the computing device 600 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 600 can support any type of interface to a user (such as “wearable” circuitry and the like).

The processing unit 610 may be a physical or virtual processor and can implement various processes based on programs stored in the memory 620. In a multi-processor system, multiple processing units execute computer executable instructions in parallel so as to improve the parallel processing capability of the computing device 600. The processing unit 610 may also be referred to as a central processing unit (CPU), a microprocessor, a controller or a microcontroller.

The computing device 600 typically includes various computer storage medium. Such medium can be any medium accessible by the computing device 600, including, but not limited to, volatile and non-volatile medium, or detachable and non-detachable medium. The memory 620 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 630 may be any detachable or non-detachable medium and may include a machine-readable medium such as a memory, flash memory drive, magnetic disk or another other media, which can be used for storing information and/or data and can be accessed in the computing device 600.

The computing device 600 may further include additional detachable/non-detachable, volatile/non-volatile memory medium. Although not shown in FIG. 6, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 640 communicates with a further computing device via the communication medium. In addition, the functions of the components in the computing device 600 can be implemented by a single computing cluster or multiple computing machines that can communicate via communication connections. Therefore, the computing device 600 can operate in a networked environment using a logical connection with one or more other servers, networked personal computers (PCs) or further general network nodes.

The input device 650 may be one or more of a variety of input devices, such as a mouse, keyboard, tracking ball, voice-input device, and the like. The output device 660 may be one or more of a variety of output devices, such as a display, loudspeaker, printer, and the like. By means of the communication unit 640, the computing device 600 can further communicate with one or more external devices (not shown) such as the storage devices and display device, with one or more devices enabling the user to interact with the computing device 600, or any devices (such as a network card, a modem and the like) enabling the computing device 600 to communicate with one or more other computing devices, if required. Such communication can be performed via input/output (I/O) interfaces (not shown).

In some embodiments, instead of being integrated in a single device, some or all components of the computing device 600 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 600 may be used to implement point cloud encoding/decoding in embodiments of the present disclosure. The memory 620 may include one or more point cloud coding modules 625 having one or more program instructions. These modules are accessible and executable by the processing unit 610 to perform the functionalities of the various embodiments described herein.

In the example embodiments of performing point cloud encoding, the input device 650 may receive point cloud data as an input 670 to be encoded. The point cloud data may be processed, for example, by the point cloud coding module 625, to generate an encoded bitstream. The encoded bitstream may be provided via the output device 660 as an output 680.

In the example embodiments of performing point cloud decoding, the input device 650 may receive an encoded bitstream as the input 670. The encoded bitstream may be processed, for example, by the point cloud coding module 625, to generate decoded point cloud data. The decoded point cloud data may be provided via the output device 660 as the output 680.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for point cloud coding, comprising:
determining, for a current point in a current point cloud (PC) sample of a point cloud sequence during a conversion between the current PC sample and a bitstream of the point cloud sequence, at least one neighboring point from a set of points in a reference PC sample of the current PC sample based on a first geometric distance;
determining at least one weight associated with the at least one neighboring point based on a second geometric distance, the second geometric distance being different from the first geometric distance; and
performing the conversion based on the at least one weight and the at least one neighboring point.

2. The method of claim 1, wherein the at least one neighboring point is stored in a predictor list.

3. The method of claim 1, wherein the at least one neighboring point comprises a target point, a first geometric distance between the target point and the current point being the smallest among first geometric distances between the current point and respective points in the set of points.

4. The method of claim 1, wherein the first geometric distance is determined based on Manhattan distance.

5. The method of claim 1, wherein the set of points are defined by a search center and a search range.

6. The method of claim 1, wherein the set of points is comprised in a group of level of details (LODs) of the reference PC sample.

7. The method of claim 6, wherein determining the at least one neighboring point comprises:
determining the at least one neighboring point by performing nearest neighbor search on the set of points.

8. The method of claim 7, wherein the set of points comprise at least one of the following:
points at the same LOD level as the current point,
points at a LOD level lower than the current point, or
points at a LOD level higher than the current point.

9. The method of claim 1, wherein performing the conversion comprises:
obtaining a compensated reference PC sample by applying motion compensation on the reference PC sample;
determining a predicted attribute value of the current point based on the at least one neighboring point and the compensated reference PC sample; and
performing the conversion based on the predicted attribute value.

10. The method of claim 1, wherein performing the conversion comprises:
determining a predicted attribute value of the current point based on the at least one neighboring point and the reference PC sample; and
performing the conversion based on the predicted attribute value.

11. The method of claim 1, wherein a third indication indicating whether motion compensation is applied on the reference PC sample is comprised in the bitstream.

12. The method of claim 2, wherein the predictor list is generated by combining a plurality of lists for storing neighboring points of the current point that are determined from different PC samples.

13. The method of claim 1, wherein the current PC sample is a slice within a point cloud frame in the point cloud sequence.

14. The method of claim 1, wherein the conversion includes encoding the current PC sample into the bitstream.

15. The method of claim 1, wherein the conversion includes decoding the current PC sample from the bitstream.

16. An apparatus for processing point cloud data comprising a processor and a non-transitory memory with instructions thereon, wherein the instructions upon execution by the processor, cause the processor to perform acts comprising:
determining, for a current point in a current point cloud (PC) sample of a point cloud sequence during a conversion between the current PC sample and a bitstream of the point cloud sequence, at least one neighboring point from a set of points in a reference PC sample of the current PC sample based on a first geometric distance; and
determining at least one weight associated with the at least one neighboring point based on a second geometric distance, the second geometric distance being different from the first geometric distance; and
performing the conversion based on the at least one weight and the at least one neighboring point.

17. The apparatus of claim 16, wherein the set of points is comprised in a group of level of details (LODs) of the reference PC sample.

18. A non-transitory computer-readable storage medium storing instructions that cause a processor to perform acts comprising:
determining, for a current point in a current point cloud (PC) sample of a point cloud sequence during a conversion between the current PC sample and a bitstream of the point cloud sequence, at least one neighboring point from a set of points in a reference PC sample of the current PC sample based on a first geometric distance; and
determining at least one weight associated with the at least one neighboring point based on a second geometric distance, the second geometric distance being different from the first geometric distance; and
performing the conversion based on the at least one weight and the at least one neighboring point.

19. The non-transitory computer-readable storage medium of claim 18, wherein the set of points is comprised in a group of level of details (LODs) of the reference PC sample.

20. A non-transitory computer-readable recording medium storing a bitstream of a point cloud sequence which is generated by a method performed by a point cloud processing apparatus, wherein the method comprises:
determining, for a current point in a current point cloud (PC) sample of the point cloud sequence, at least one neighboring point from a set of points in a reference PC sample of the current PC sample based on a first geometric distance;
determining at least one weight associated with the at least one neighboring point based on a second geometric distance. the second geometric distance being different from the first geometric distance; and
generating the bitstream based on the at least one weight and the at least one neighboring point.
